(19) United States
(12) Patent Application Publication
(10) Pub. No.: US 2007/0160363 A1
(43) Pub. Date: Jul. 12, 2007

(54) FRAMING FEATURE FOR IMAGING MECHANISMS AND SYSTEMS

(76) Inventor: Richard Corton, Sherman Oaks, CA (US)

Correspondence Address: THELEN REID BROWN RAYSMAN & STEINER, LLP, 900 THIRD AVENUE, NEW YORK, NY, 10022, US

(21) Appl. No.: 11/462,970

(22) Filed: Aug. 7, 2006

Related U.S. Application Data
(60) Provisional application No. 60/705,820, filed on Aug. 5, 2005.

(51) Int. Cl. G03B 13/10

(52) U.S. Cl. 396/380

(57) ABSTRACT

Embodiments disclosed herein are directed to a framing feature for cropping photographs. According to one embodiment, the framing feature is associated with a camera. The camera has a body including a lens, a viewfinder positioned within the body, and a framing structure. The framing structure includes a transparent member having a set of one or more framing outlines provided thereon, and the framing structure is coupled to the body such that one or more framing outlines are positionable over the viewfinder.

### CROSS-REFERENCE TO RELATED APPLICATIONS

This application is a non-provisional application that claims the benefit of U.S. provisional patent application No. 60/705,820, filed Aug. 5, 2005, which is herein incorporated by reference in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF INVENTION

Embodiments disclosed herein pertain to framing features for photographic imaging mechanisms and systems, which facilitates the making of a photographic image in which the subject of the image is so sized and framed that the subject is depicted in a desired way upon cropping of a print of the image to a selected shape.

### BACKGROUND

Photographs are displayed or presented in a wide range of formats such as, but not limited to, scrap books, picture frames of varying sizes, keepsakes such as a locket, pendants and other articles of jewelry. Typically, photographs are printed in standard sizes such as 4″×6″ or 5″×7″ photos. In certain situations, these standard-sized photographs need to be cropped to the desired shape and size of a particular application.

However, cropping a photograph is a time-consuming and difficult process given the desired shape or size of the photograph. That is, an individual has to measure and cut the photograph to a particular size and/or shape. This may be a trial and error process that takes time to properly crop the photo. There is also the possibility that the photo may be damaged or improperly cropped thereby ruining the picture for the intended application. Furthermore, a photograph may not lend itself to be cropped, as the subject image in the photograph may be too large or too small for the best presentation in the finished article. Accordingly, what is needed is devices and systems for framing photographic images to a selected shape.

### SUMMARY

Briefly, and in general terms, various embodiments are directed to a framing feature for cropping photographs. According to one embodiment, the framing feature is associated with a camera. The camera has a body including a lens, a viewfinder positioned within the body, and a framing structure. The framing structure includes a transparent member having a set of one or more framing outlines provided thereon, and the framing structure is coupled to the body such that one or more framing outlines are positionable over the viewfinder.

In another embodiment, the camera is a digital camera having a framing feature. The digital camera has a body including a lens on a first side of the body, a viewfinder positioned within the body, a liquid crystal display (LCD) positioned in the body opposite the first side of the body, and a means for digitally cropping at least a portion of a digital image, wherein the digitally cropped image is displayable on the LCD.

In yet another embodiment, a system for cropping photographs is disclosed herein. The system includes a digital camera in communication with a printer. According to one embodiment, the digital camera has a means for digitally cropping a portion of a digital image. The printer is capable of printing digital images having a desired size and shape, wherein the shape is a circle, star, polygon, or any amorphous shape.

Other features and advantages will become apparent from the following detailed description, taken in conjunction with the accompanying drawings, which illustrate by way of example, the features of the various embodiments.

### BRIEF DESCRIPTION OF THE DRAWING

FIG. 1 is a front elevation view of a paper jacketed disposable camera equipped with structure defining a one embodiment of framing feature;

FIG. 2 is an elevation view of a transparent strip carrying desired framing outlines and useful as a component of the framing structure depicted in FIG. 1;

FIG. 3 is a front view of the form or blank for the camera jacket of the camera depicted in FIG. 1;

FIG. 4 is a rear view of the camera jacket form or blank shown in FIG. 3;

FIG. 5 is a fragmentary cross-sectional elevation view taken along line 5-5 in FIG. 4;

FIG. 6 is a front view of another embodiment of a camera jacket form for another embodiment of a framing feature;

FIG. 7 is a rear view of the camera jacket form shown in FIG. 6;

FIG. 8 is a front elevation view of a camera to which is fitted, as an accessory, another embodiment of a framing feature structure;

FIG. 9 is a perspective view of the framing feature accessory shown in FIG. 8;

FIG. 10 is a perspective view of another embodiment of a framing accessory for framing feature structure;

FIG. 11 illustrates an embodiment of a system which includes a digital camera, a printer, a computer, and die cut printer stock material;

FIG. 11A is an elevation view of the rear of the digital camera depicted in FIG. 11 and shows a selected framing outline in the image displayed in the camera view finder (viewscreen);

FIG. 12 illustrates another embodiment of a system, which includes a digital camera and a computer-based printer to which the camera can be directly coupled;

FIG. 13 illustrates front view of one embodiment of a digital camera having a framing feature;

FIG. 14 illustrates a back view of the digital camera of FIG. 13;

FIG. 15 illustrates a back view of the digital camera of FIG. 14 showing an image after the image has been cropped; and

FIG. 16 illustrates a screen shot of a digitally cropped image of FIG. 15 superimposed on a new background image.

### DETAILED DESCRIPTION

Embodiments disclosed herein are directed to mechanisms and systems having a framing feature that crops a photographic image to a desired size and shape. The cropped image may be used in a picture frame or an article of personalized jewelry or the like. In one embodiment, a camera includes a camera viewfinder having an image of a selected outline having a shape and size that corresponds to the shape and size of a picture frame or an article of personalized jewelry. According to one embodiment, the selected outline is defined on a transparent member positionable across the optical axis of the camera viewfinder. The transparent member is a component of an accessory demountably attachable to the camera as a camera accessory or the like. The transparent member can be incorporated into a case, jacket or covering for the camera which does not obstruct the camera lens or viewfinder during use of the camera. In another embodiment, the selected outline is generated in the viewfinder image of a single lens reflex (SLR) camera by a selectively operable mechanism built into the camera. The outline produced by the outline generator may or may not be manifested in a photograph taken with the camera. Alternatively, the selected outline image may be produced by software and related structure incorporated into a digital camera. The framing outline may or may not be manifested in a photograph taken with the camera. Also, the framing feature can be provided by image manipulation software used in connection with the creation of a print of a photographic image recorded or made available in digital form by a suitable computer-based printer.

For example, the cropped photographs may be used to create personalized jewelry and the like. A market is developing for pendants and other articles of jewelry in which the image of a person, several persons, a pet or the like is presented by the pendant, e.g., in such an article, a photograph of a desired subject, selected by a person for whom the article is to be specially made, is used to provide the image. If a pendant, e.g., is desired in a square, oval, teardrop or other desired shape, a photograph of the subject can be cropped to the desired shape and size for use as a component of the pendant. In another example, the cropped photographs may be used to create decals (e.g., Iron-on or Static Cling) that may be applied to T-shirts, notebooks, windows, or other surfaces.

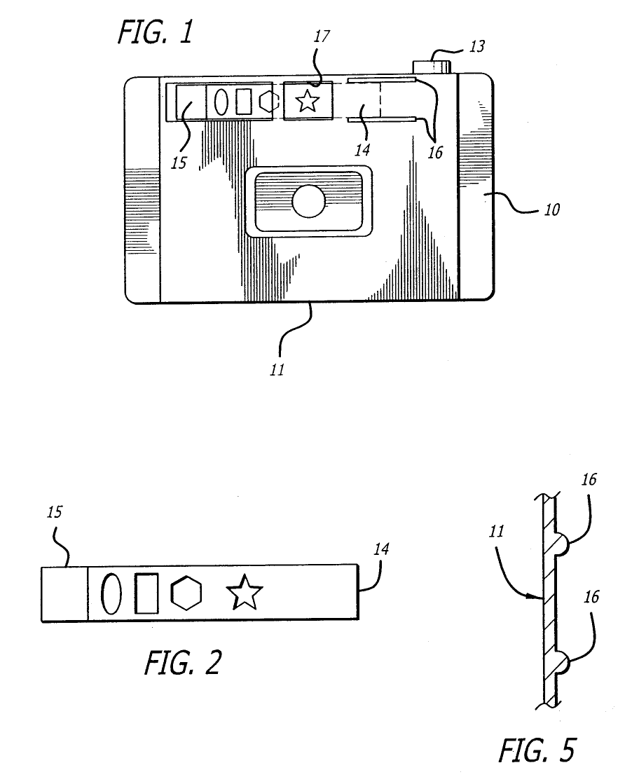

Referring now to the drawings, wherein like reference numerals denote like or corresponding parts throughout the drawings and, more particularly to FIGS. 1-12, there are shown various embodiments of a framing feature structure that is usable with a disposable or SLR-type cameras. More specifically, FIG. 1 is a front elevation view of one embodiment of a disposable camera 10 that includes a first style of framing feature structure. In this embodiment, the body of camera 10 is encircled by a sleeve or band 11 of paperboard or heavy paper stock in which are formed suitable apertures to accommodate the camera lens 12, a viewfinder located in the camera above the lens, and a shutter release actuator button 13. The viewfinder aperture in the sleeve is denoted at 17. The camera jacket 11 includes structural aspects, which comprise a part of the structure of the framing feature.

Another component of the structure of the camera framing feature is an elongate slider strip 14 of transparent material on which are imprinted, e.g., at locations spaced along the middle of slider strip 14, a plurality of framing outlines of selected size and shape, such as an oval, a rectangle, a hexagon, a star, and any other outline configurations which may be desired. An end of strip 14 can be defined as a tab 15 by which a user of the camera can engage the strip, as by use of one or two fingertips, to move the strip for positioning of a desired outline in front of the camera viewfinder. An end portion of strip 14 opposite from tab 15 can be devoid of imprinted outlines so that, when such strip end portion is positioned in front of the camera viewfinder, the camera can be used in a normal manner without perception by the camera user that the camera is equipped with the elongate slider strip 14. The slider strip 14 can be movably carried by the camera jacket 11 in a manner which locates and aligns the slider strip so that the slider strip traverses the viewfinder objective lens and the longitudinal centerline of the strip (on which each of the several framing outlines imprinted on the strip is centered) transversely intersects the optical axis of the viewfinder lens system.

Assume that a user of the camera desires to photograph a child, e.g., and to use a cropped print of that photograph in a personalized piece of jewelry (such as a pendant) of the kind described above. The user desires a pendant having a hexagonal shape of a specified size. If, as may be preferred, the sizes and shapes of the framing outlines carried by slider strip 14 are correlated to the sizes and shapes of a series of pendants available to the user, the camera user can move the slider strip 14 to place the hexagonal outline on the strip in a centered position in front of the camera viewfinder. The user may then position the camera relative to the child in terms of distance and alignment so that the desired portion of the image of the child, as seen through the viewfinder, is desirably within the hexagonal framing outline, which also is seen through the viewfinder. With the camera so positioned, a photograph of the child is taken. A print of that photograph can be cropped to the desired hexagonal size in a way which places the child's image in the center of that photo as so cropped and that cropped image then can be used quite effectively to provide the desired pendant.

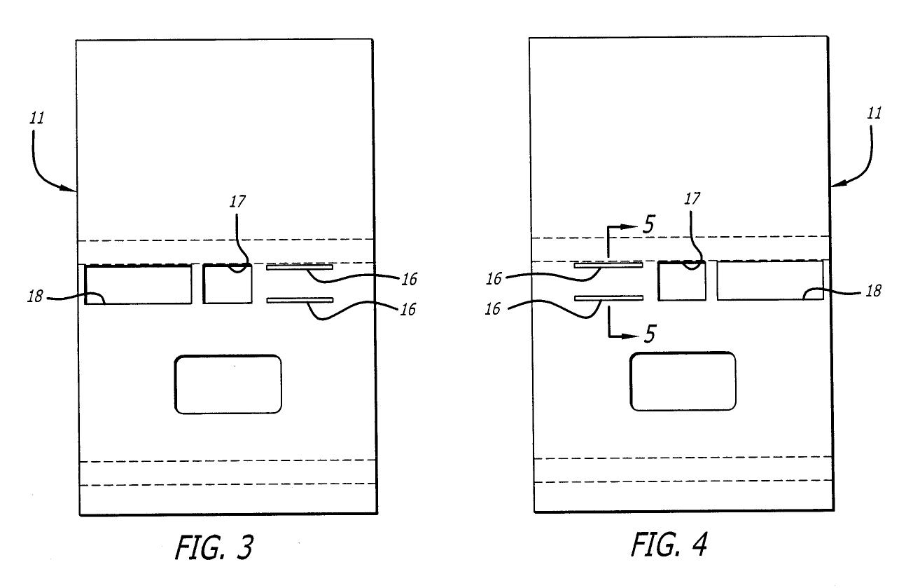

In the embodiment depicted in FIGS. 1, 3, and 4, the structural features that support the slider strip 14 and guide its movement across the front of the camera viewfinder include a pair of elongate and parallel spaced guides 16 defined in sleeve 11 to one side of a viewfinder aperture 17 in the sleeve, and an elongate and preferably rectangular aperture 18 in the sleeve adjacent to the other side of the sleeve's viewfinder aperture. Guides 16 are spaced from each other by an amount, which is slightly greater than the width of slider strip 14. The width of sleeve aperture 18 also is slightly greater than the width of the slider strip. These features are shown best in FIGS. 3 and 4 which are elevation views of the front and back of a paperboard, e.g., sleeve form or blank, after basic formation as by die cutting and scoring, in a flat state before being folded and glued and put into position around the body of camera 10 in a manner which is conventional. Parallel guides 16 preferably extend from the rear surface of the sleeve for cooperation with a front surface of the camera when the sleeve has been installed around the camera body. The rear surface of the sleeve between guides 16, the guides, and the front surface of the camera form a straight passage into which the slider strip can enter and be guided in moving along the passage. After the sleeve 11 with its rearwardly extending guides 16 has been installed around the camera body, the end 20 of slider strip 14 opposite from tab 15 can be introduced through aperture 18, slid under the portion of the sleeve which exists between apertures 17 and 18, passed across the front of the viewfinder, and then introduced under the sleeve and into the passage defined between guides 16. The slider strip is movable across the viewfinder so that any selected increment of the length of the strip can be placed in front of the viewfinder.

While guides 16 can be provided by structure added to sleeve 11, in one embodiment, the guides 16 are integral with the sleeve as elongate straight and parallel dimples or the like raised from the rear surface of the sleeve; see FIG. 5. Dimple guides can be formed in the sleeve material as part of the die cutting and scoring operations preferably used to define the sleeve blank, such as is shown in FIGS. 3 and 4.

It will be appreciated that, the size of a framing outline, such as the outline on slider strip 14, is coordinated with a photographic print of a defined size, or degree of enlargement. It is within the scope of this invention that, at each station along slider strip 14, e.g., where a framing outline is provided, there may be a set of concentric outlines of the same shape. Each outline in the set can be correlated to a specified degree of enlargement of the photograph image when that image is manifested as a photographic print; that aspect of the invention can be implemented in cameras in which an outline forming mechanism is built into a camera, such as a single line reflex camera or a digital camera.

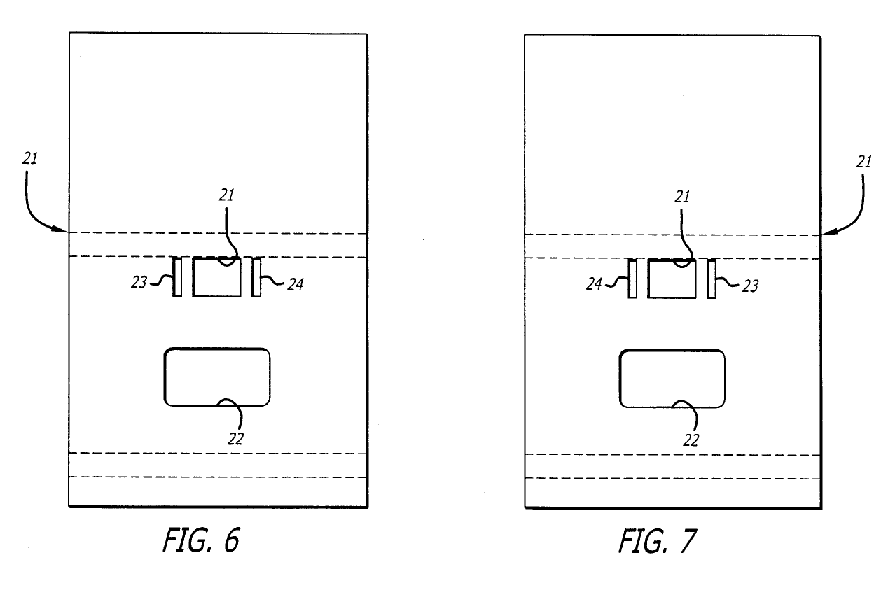

FIGS. 6 and 7 are elevation views of the front and rear surfaces of another embodiment of disposable camera sleeve blank 21 as die cut and scored to be ready for installation around the body of a disposable camera. The sleeve blank 21 defines a viewfinder aperture 22 and an aperture 23, which accommodates the camera lens and adjacent features of the body of a disposable camera. The viewfinder aperture 22 can be rectangular with vertical side edges. Vertically elongate slots 24 and 25 are formed in the sleeve blank closely adjacent to each side of the viewfinder aperture. Each slot 24 and 25 has a height that is slightly greater than the width of a suitable outline-bearing transparent slider strip, such as points of the heights of the slots traverses the optical axis of the camera viewfinder in the installed position of the sleeve blank around the body of a disposable camera. Either before or after the sleeve blank has been installed around the camera body, the end of the slider strip can be passed through aperture 23 and under the adjacent portion of the sleeve, across the front of the viewfinder, under the sleeve portion between aperture 21 and slot 24, and then out through slot 24. The opposite tab end of the slider strip can be engaged manually to slide the slider strip, as so threaded through the camera sleeve, to position the slider strip as desired relative to the viewfinder axis.

Particularly in the context of disposable cameras having encircling paperboard bands or sleeves around them, the slider strip guides can be glued or otherwise affixed to the sleeves, in association with a camera viewfinder. In that way, a disposable camera of conventional manufacture can be equipped with the present framing feature after the sleeve has been secured around the camera body.

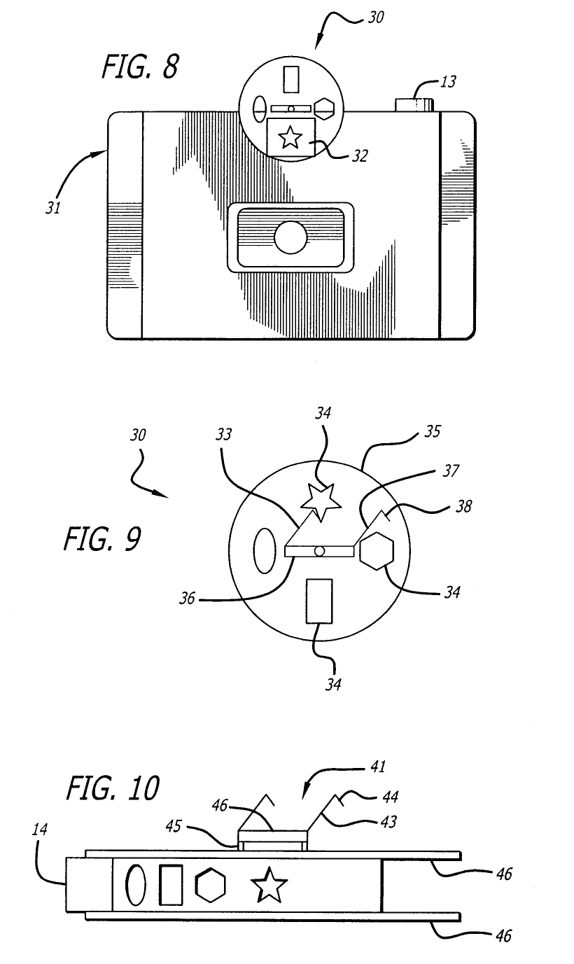

FIGS. 8 and 9 illustrate an accessory 30 for a nondisposable camera 31. The camera 31 has a viewfinder 32, which opens through an upper part of the front face of the camera. The accessory 30 provides the framing feature structure when the accessory is mounted, either permanently or detachably, to the camera 31 in association with the viewfinder 32. Accessory 30 includes a frame 33 and a preferably thin transparent element, which is movably mounted to the frame. On a surface of the transparent element are imprinted, or otherwise suitably defined, a plurality of framing outlines 34. Each outline is spaced from the others and has a desired position on the transparent element.

In the accessory shown in FIGS. 8 and 9, the transparent element is in the form of a circular disk or wheel 35. The frame 33 of the accessory 30 is defined by a substantially rigid material that has a desired measure of resilient flexibility. The frame 33 can be generally U-shaped with a central relatively stiffer central bar or body 36 and relatively less stiff preferably parallel arms 37 extended in the same direction relative to the body from each end of the body. A gripping lug 38 extends out of the preferably common plane of the body and the arms at each of the opposite ends of each arm. The distance between the lugs associated with each arm 37, and the lengths of the lugs, are defined so that the accessory frame 33 can be detachably affixed or clipped onto camera 31 directly above viewfinder 32 as shown in FIG. 8. As so mounted to the camera, a portion of transparent wheel, rotatably mounted at its center to the mid-length, e.g., of the frame body, extends downwardly in front of the viewfinder. The positioning of the framing outlines 34 on wheel 35 can be such that each outline 34 can be centered on the viewfinder axis as the wheel is rotated. The manner of use of accessory 30 will be apparent from the foregoing descriptions.

FIG. 10 is a perspective view of another embodiment of an accessory 40 for camera 31. Accessory 40 includes a frame 41 having a body 42 which can be much like frame body 36 of accessory 30 and a pair of arms 43 much like the arms of frame 33. A gripping lug 44 depends from the end of each arm, which is remote from body 42. A pair of legs 45 depends from body 42 at or near the appropriate ends of the body. The legs support a pair of elongate channel-like guides 46 which are parallel to each other and are spaced adequately from each other to slidably carry between them a slider strip 14. Lugs 44 and legs 45 can cooperate with each other to provide an arrangement by which accessory 40 can be detachably mounted to camera 31, e.g., to place the centerline of slider strip 14 in a centered position in front of viewfinder 32. The manner of use of accessory 40 will be apparent from the foregoing descriptions.

As noted above, arrangements to provide framing outlines of desired shape and size in the viewfinder images of other kinds of cameras, each as digital cameras and SLR cameras, may be included within the structure of such cameras. For example, in an SLR camera, the framing outline is positioned in a location along the optical path between the lens and the film. Depending on the nature of the camera, the framing outlines (or sets of outlines of common shape but of different sizes) can be made visible in the camera viewfinder. Where a single outline is presented (or a particular outline in a set of them is selected for viewfinder display), the camera structure (such as in a digital camera) may be defined to optionally include the framing outline in the image recorded by the camera. The presence of the framing outline in the photographic image can assist in efficient cropping of a print of that image. Another contemplated utility of this invention is in support of the sale of “collage” picture frames, i.e., picture frames which include a mat or the like which defines a number of openings of different shapes and sizes. In the use of such picture frames, portions of different photographs are visible in the mat openings. The photographs are positioned between the mat and a backboard in the assembled state of the frame. In an alternate embodiment, the framing feature structure may include opening of various sizes that correspond to different sizes of photos that are used to create scrapbooks.

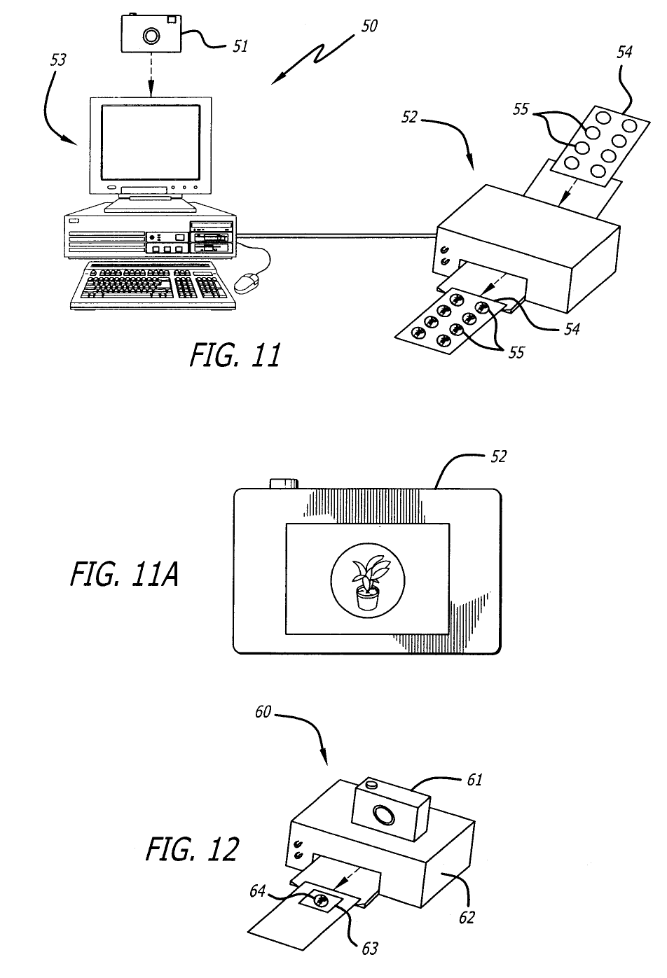

According to one embodiment, a system 50 for framing (i.e., cropping) a picture includes a digital camera 51 having a viewfinder 56 in which a selected framing outline 57 can be displayed (see FIG. 11A), a printer 52 which can be and preferably is a printer controlled by a computer 53 equipped with suitable software for manipulating and editing digital images and for controlling operation of the printer, and a sheet (or sheets) of die cut, preferably self-adhesive paper or other sheet stock material 54. The stock material 54 can have its face sheet die cut to define a plurality of removable areas of desired size and shape such as, but not limited to, circles 55, stars, polygons, or any amorphous shapes. In this embodiment, the printer 52 may be an ink-jet or laser printer. Additionally, other outputting mechanisms using dye sublimation, heat transfer, or silver halide may be used to produce a cropped photographic image.

The computer 53 can receive digital files, each containing the data for a respective image recorded by the camera 51, preferably by use of a viewfinder framing outline 57 as described above. By use of the image manipulation and editing software available in the computer 53, the computer can be used to confirm or adjust framing of a desired subject in the image received from the camera 51. Alternatively, the computer 53 may be used to produce a desired framing outline and to position and size the desired subject in the desired framing outline if the camera does not provide a suitable framing outline in the overall viewfinder image. The computer 53 can be used, because of its software, to produce registry of the image of the desired subject with a selected one of the die cut area 55 on the sheet of stock material and to control operation of the printer to print that subject image within the perimeter of that selected outline 55, as depicted in FIG. 11 in the output from the printer. If desired, the computer can be used to bleed the desired image within or outside the perimeter of the selected die cut area 55. Also, if desired the computer 53 can be used to cause the printer 52 to print the desired image in more than one of the die cut areas of the face sheet of sheet material 54. The printer 52 can be commanded to print only in an area 55 or to print the complete image recorded by the camera 51 with the desired content centered suitably on the sheet. In other embodiments, new shapes used for cropping digital images may be downloaded to the computer 53 (and optionally uploaded to the camera 51). Alternatively, the new shapes may be directly downloaded to the camera 51 or printer 52. In yet another embodiment, the user may design a particular shape that may be downloaded to the computer 53, camera 51, or printer 52.

According to another embodiment, the framing feature as software useable in a system, similar to system 50, which includes a computer for receiving digital image files from a digital camera, which does not create such files with framing outlines included in the data in those files. The framing feature software can be a standalone application program which enables a user to select a framing outline from the program inventory of outlines, to adjust the size of the selected framing outline, to move the selected and sized framing outline relative to the camera-created image, and to incorporate the positioned outline into the data supplied to a printer operable to print the camera-created image with the selected, sized and positioned outline in the printer output. Alternately, framing feature software can be provided to mark with other digital image file manipulation software such as, but not limited to, Adobe® Systems Incorporated's Photoshop® software, Corel Photo-Paint, Paint Shop Pro, Visualizer Photo Studio, Pixel image editor, or PixBuilder Photo Editor, to include a framing outline of selected shape and size in a desired position in each image produced by a printer controlled by a computer, which includes the software programs.

FIG. 12 shows another system 60 in which a digital camera 61 can be mated directly with a printer 62 structure to make electrical connection with the camera to receive digital image files from the camera and to produce prints 63 of the images defined in those files. If the camera 61 has the features of camera 51 (including the ability to include a framing outline 64 of selected size and shape in a desired image file), the image print 63 produced by the printer can include that outline; the print is readily trimmed or cropped for use as desired.

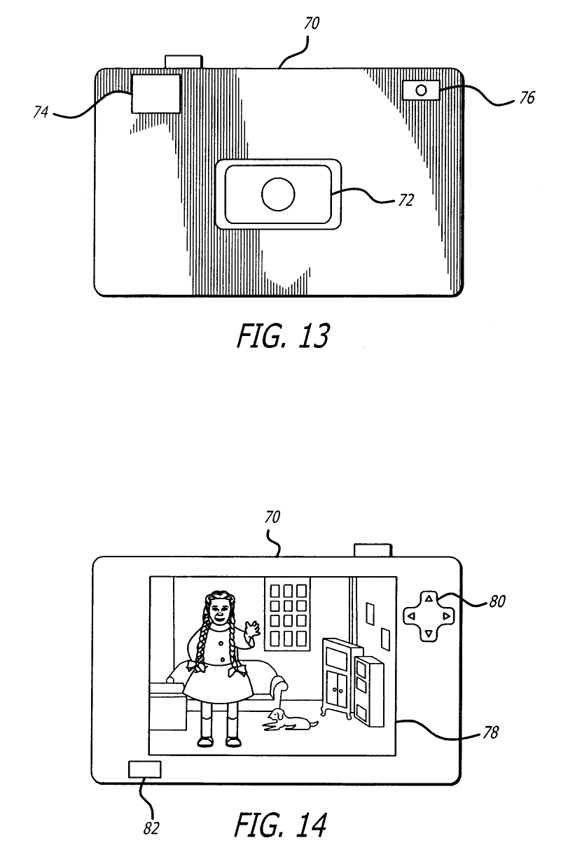

FIGS. 13-14 illustrate one embodiment of a digital camera 70 having a framing feature. The framing feature allows a user to isolate/capture a portion of a photographic image. In this embodiment, the camera includes a lens 72, flash 74, and a sensor 76 on the front of the camera 70. The sensor 76 may be the type of sensor that detects heat, light, motion, sound (i.e., sonar waves), depth, or a combination thereof. FIG. 14 illustrates the back of the camera 70 that includes a liquid crystal display (LCD) 78, a menu/cursor control button 80, and an output connection 82. The output connection may be a USB connection, FireWire (IEEE 1394 High Speed Serial Bus), Digital Video (DV), or other type of connection known or developed in the art. As those skilled in the art will appreciate, the camera 70 may include one or more output connections.

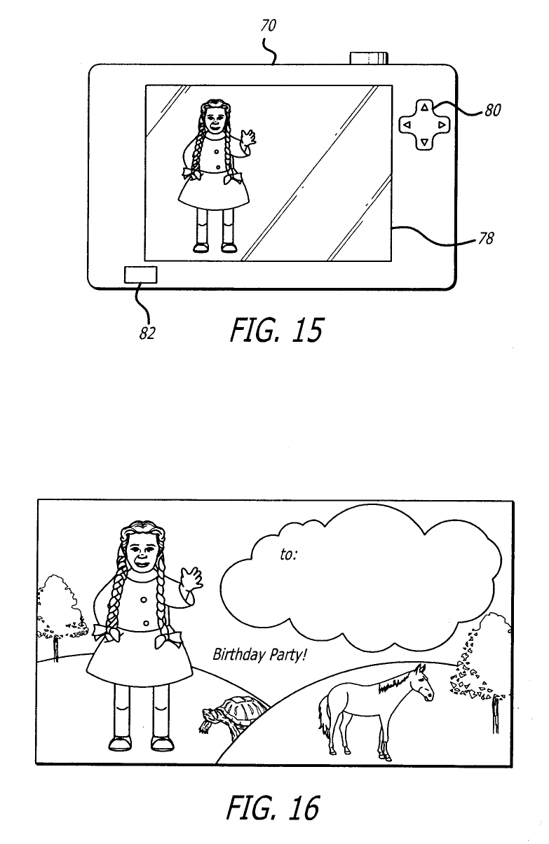

In this embodiment, the sensor 76 allows the user to characterize and/or distinguish a subject image from the background of a photograph image. As a result, the framing feature is able to crop the picture around one or more image subjects. For example, as shown in FIG. 15, the framing feature is able to crop around the little girl and remove the background of the photographic image of FIG. 14. The cropped image of the little girl may then be superimposed on a whimsical background as shown in FIG. 16. Alternatively, the cropped image may be superimposed on another picture. In yet another embodiment, the cropped image may be printed on a “blue screen” or any blank background. With the digital camera 70, the user is able to crop a photographic image using the menu/cursor button 80 without requiring the user to use a secondary device such as a computer to electronically crop the photographic image or manually crop a hard copy of the photographic image. As those skilled in the art will appreciate, the camera 70 may include software that uses layering and transparency techniques to remove a subject image from the background. Alternatively, other techniques known or developed in the art may be utilized to remove a subject image from the background of a photographic image.

In another embodiment, the digital camera 70 does not include a sensor with the framing feature. Rather, in this embodiment, the digital camera includes a framing feature that uses pixel differentiation to determine the outline or edge of a subject image. That is, based upon a change in color, shading, and/or brightness of adjacent pixels, the framing feature may differentiate a subject image from other images or backgrounds of the captured image. In yet another embodiment, the user may use the menu/cursor control button 80 to manually outline a portion of the digital image to define the area of the image to be cropped. Alternatively, the cursor button 80 may be used to activate other functions such as a lasso to define the area to be cropped in a digital image.

As those skilled in the art will appreciate, vector graphics editors and raster graphics editors may be used to capture a portion of a digital photographic image. Furthermore, as those skilled in the art will appreciate, while the framing feature is described as a feature of a digital camera, the framing feature may be used with a video camera or other image capturing devices.

The various embodiments described above are provided by way of illustration only and should not be construed to limit the claimed invention. Those skilled in the art will readily recognize various modifications and changes that may be made to the claimed invention without following the example embodiments and applications illustrated and described herein, and without departing from the true spirit and scope of the claimed invention, which is set forth in the following claims.

What is claimed:

1. A camera having a framing feature for cropping a photograph, the camera comprising:
a body including a lens;
a viewfinder positioned within the body; and
a framing structure including a transparent member having a first set of one or more framing outlines provided thereon, wherein the framing structure is coupled to the body such that one or more framing outlines are positionable over the viewfinder.

2. The camera of claim 1, further comprising a second set of one or more framing outlines that correspond to the first set of framing outlines, wherein one of the framing outlines from the second set is positionable between lens and film so that an image of the framing outline appears on a photograph.

3. The camera of claim 1, wherein the transparent member is an elongated strip slidably coupled to the body of the camera.

4. The camera of claim 1, wherein the transparent member is a disk rotatably coupled to the body of the camera.

5. The camera of claim 1, wherein the framing structure is permanently coupled to the body of the camera.

6. A camera having a framing feature for cropping a photograph, the camera comprising:
a body including a lens;
a viewfinder positioned within the body;
a body sleeve having openings corresponding to the lens and the viewfinder, wherein the body sleeve is coupled to the body;
a framing structure including a transparent member having a first set of one or more framing outlines provided thereon, wherein the framing structure is coupled to the body sleeve such that one or more framing outlines are positionable over the viewfinder.

7. The camera of claim 6, further comprising a second set of one or more framing outlines that correspond to the first set of framing outlines, wherein one of the framing outlines from the second set is positionable between lens and film so that an image of the framing outline appears on a photograph.

8. The camera of claim 6, wherein the transparent member is an elongated strip slidably coupled to the body sleeve.

9. The camera of claim 6, wherein the transparent member is a disk rotatably coupled to the body sleeve.

10. A digital camera capable of cropping a portion of a photographic image, the digital camera comprising:
a body including a lens on a first side of the body;
a viewfinder positioned within the body;
a liquid crystal display (LCD) positioned in the body opposite the first side of the body; and
a means for digitally cropping at least a portion of a digital image on the camera, wherein the digitally cropped image is displayable on the LCD.

11. The digital camera of claim 10, further comprising a sensor positioned on the first side of the body, wherein the sensor is able to detect heat, light, motion, sound, depth, or a combination thereof.

12. The digital camera of claim 10, wherein the LCD is capable of presenting one or more framing outlines that delineate an area of the digital image to be cropped, wherein the framing outline is a star, polygon, amorphous shape, or an outline of an image within the photographic image.

13. The digital camera of claim 10, further comprising at least one output connection.

14. A digital camera capable of cropping a portion of a photographic image, the digital camera comprising:
a body including a lens on a first side of the body;
a viewfinder positioned within the body;
a liquid crystal display (LCD) positioned in the body opposite the first side of the body;
a sensor positioned on the first side of the body, wherein the sensor is able to detect heat, light, motion, sound, depth, or a combination thereof; and
a means for digitally cropping a digital image on the camera into a shape of a circle, star, polygon, amorphous shape, or an outline of an image within the digital image, wherein the sensor is in operable communication with the digital cropping means, and wherein the digitally cropped image is displayable on the LCD.

15. The digital camera of claim 14, wherein the LCD is capable of presenting one or more framing outlines that delineate an area of the digital image to be cropped, wherein the framing outline is a circle, star, polygon, amorphous shape, or an outline of an image within the photographic image.

16. A system for capturing a portion of a photographic image, the system comprising:
a digital camera having a body including a lens on a first side of the body, a viewfinder positioned within the body, a liquid crystal display (LCD) positioned in the body opposite the first side of the body, and a means for digitally cropping a portion of a digital image; and
a printer in communication with the camera, wherein the printer is capable of printing digital images having a desired size and shape, wherein the shape is a circle, star, polygon, or any amorphous shape.

17. The system of claim 15, further comprising a computer having software capable of manipulating and editing digital images, wherein the computer is in communication with the digital camera or the printer.
